(19) United States
(12) Patent Application Publication
(10) Pub. No.: US 2019/0174412 A1
(43) Pub. Date: Jun. 6, 2019

(54) Wi-Fi Station Power Optimization Using Bluetooth/BLE

(71) Applicant: MediaTek Singapore Pte. Ltd., Singapore (SG)

(72) Inventors: Rahul Mahajan, New Delhi (IN); Vishal Bhargava, Noida (IN); Abhijeet Singh Katiyar, Farrukhabad (IN); Tarun Kumar Datta, Greater Noida (IN); Abhijit Uplenchwar, Noida (IN)

(21) Appl. No.: 15/831,376

(22) Filed: Dec. 4, 2017

(51) Int. Cl. H04W 52/02; H04W 68/02; H04W 4/00

(52) U.S. Cl. CPC H04W 52/0229; H04W 84/12; H04W 4/008; H04W 68/02

(57) ABSTRACT

A method and an apparatus pertaining to Wi-Fi station (STA) power optimization using coexistent low-power wireless communications capabilities may involve a processor of a first apparatus causing the first apparatus to enter a second mode from a first mode with respect to communications with a second apparatus using a first wireless communication technology via a first communication device of the first apparatus. The processor may receive a notification from the second apparatus using a second wireless communication technology different from the first wireless communication technology via a second communication device of the first apparatus. The processor may cause the first apparatus to enter the first mode or a third mode from the second mode with respect to communications with the second apparatus using the first wireless communication technology via the first communication device of the first apparatus responsive to receiving the notification.

### TECHNICAL FIELD

The present disclosure is generally related to wireless communications and, more particularly, to Wi-Fi station (STA) power optimization using coexistent low-power wireless communications capabilities.

### BACKGROUND

Unless otherwise indicated herein, approaches described in this section are not prior art to the claims listed below and are not admitted as prior art by inclusion in this section.

In general power saving approaches for STAs in an Institute of Electrical and Electronics Engineers (IEEE) 802.11 network, a STA in a power-save mode would normally wake up at every Delivery Traffic Indication Map (DTIM) beacon to check for any buffered broadcast and/or multicast messages from an access point (AP). Additionally, the STA would wake up periodically to check for any buffered unicast packet (e.g., data packets) destined for the STA. Accordingly, the requirement for a STA to wake up from the power-save mode for the sake of checking for buffered messages/packets is an overhead from the perspective of the STA. In case of an idle network, such requirement is also undesirable in terms of power consumption.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose novel schemes, solutions, techniques, methods, systems and apparatus for Wi-Fi STA power optimization.

In one aspect, a method may involve a processor of a first apparatus causing the first apparatus to enter a second mode from a first mode with respect to communications with a second apparatus using a first wireless communication technology via a first communication device of the first apparatus. The method may also involve the processor receiving a notification from the second apparatus using a second wireless communication technology different from the first wireless communication technology via a second communication device of the first apparatus. The method may further involve the processor causing the first apparatus to enter the first mode or a third mode from the second mode with respect to communications with the second apparatus using the first wireless communication technology via the first communication device of the first apparatus responsive to receiving the notification.

In one aspect, a method may involve a processor of an access point (AP) receiving one or more packets destined for a user equipment (UE) which is in a power-save mode with respect to communications with the AP using a first wireless communication technology. The method may involve the processor buffering the one or more packets in a storage device of the AP. The method may involve the processor transmitting a notification to the UE regarding the one or more packets using a second wireless communication technology different from the first wireless communication technology via a second communication device of the AP. The method may also involve the processor receiving a response from the UE using the first wireless communication technology via a first communication device of the AP. The method may further involve the processor transmitting the one or more packets to the UE using the first wireless communication technology via the first communication device of the AP responsive to receiving the response.

In one aspect, an apparatus implementable in or as a UE may include a first communication device, a second communication device, and a processor operatively coupled to the first communication device and the second communication device. The first communication device may be capable of wireless communications using a first wireless communication technology. The second communication device may be capable of wireless communications using a second wireless communication technology different from the first wireless communication technology. The processor may be capable of causing the apparatus to enter a second mode from a first mode with respect to communications with an AP using the first wireless communication technology via the first communication device. The processor may be also capable of receiving a notification from the AP using the second wireless communication technology via the second communication device. The processor may be further capable of causing the apparatus to enter the first mode or a third mode from the second mode with respect to communications with the AP using the first wireless communication technology via the first communication device responsive to receiving the notification.

It is noteworthy that, although description of the proposed scheme and various examples is provided below in the context of wireless communications in accordance with the IEEE 802.11, Bluetooth and BLE standards, the proposed schemes, solutions, techniques, methods, systems and apparatus and any variation(s)/derivative(s) thereof may be implemented in communications in accordance with other protocols, standards and specifications where implementation is suitable. Thus, the scope of the proposed scheme is not limited to the description provided herein.

### BRIEF DESCRIPTION OF THE DRAWINGS

The accompanying drawings are included to provide a further understanding of the disclosure, and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which schemes, solutions, techniques and methods in accordance with the present disclosure may be implemented.

FIG. 2 is a diagram of an example scenario in accordance with an implementation of the present disclosure.

FIG. 3 is a diagram of an example scenario in accordance with an implementation of the present disclosure.

FIG. 4 is a block diagram of an example system of a first apparatus and a second apparatus in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Under a proposed scheme, the capabilities of wireless communications in accordance with the IEEE 802.11 as well as the Bluetooth/BLE standards are present in a user equipment (UE) or STA, as a single device, as well as in an AP. Under the proposed scheme, a communication channel based on Bluetooth/BLE may be utilized to communicate Wi-Fi peer information independent of Wi-Fi operating channel. Advantageously, under the proposed scheme, power consumption in a Wi-Fi STA due to periodic wakeup on every DTIM may be reduced. Thus, the STA may conserve power more efficiently, and may decide to wake up in case of genuine necessity. As for the AP, memory consumption due to buffering of packets for STA(s) in power-save mode may be reduced as a result of the immediate delivery/notification of buffered data/packets for STA(s) in power-save mode.

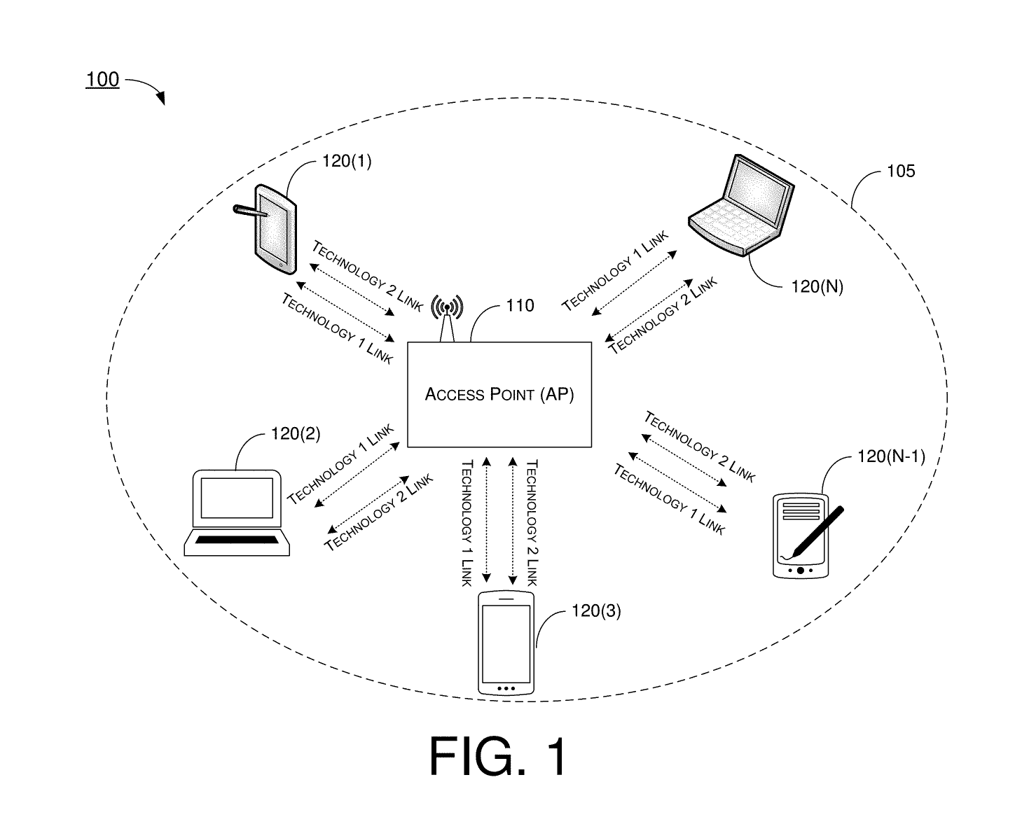

FIG. 1 illustrates an example network environment 100 in which schemes, solutions, techniques and methods in accordance with the present disclosure may be implemented. Referring to FIG. 1, in network environment 100 an access point 110, or AP 110, and a number of associated STAs 120(1)-120(N), with N being a positive integer, may form a network 105 (e.g., basic service set (BSS)). That is, each of STAs 120(1)-120(N) may engage in wireless communications (e.g., receiving and transmitting data) with AP 110 in accordance with a first wireless communication technology and a second wireless communication technology. That is, there may be two wireless communication links established between AP 110 and each of STAs 120(1)-120(N), namely: a first communication link (denoted as “technology 1 link” in FIG. 1) based on the first wireless communication technology and a second communication link (denoted as “technology 2 link” in FIG. 1) based on the second wireless communication technology. Thus, at a given point in time, each of STAs 120(1)-120(N) may be in communication with AP 110 via either or both of the first communication link and the second communication link.

The first wireless communication technology may be a radio frequency (RF)-based wireless communication technology in compliance with the IEEE 802.11 specifications, protocols and standards. The second wireless communication technology may be an RF-based wireless communication technology in compliance with the Bluetooth/BLE specifications, protocols and standards. Alternatively, each of the first wireless communication technology and the second wireless communication technology may be different wireless communication technologies. In any case, in the present disclosure, STAs 120(1)-120(N) may consume less power when communicating with AP 110 by using the second wireless communication technology than using the first wireless communication technology. For simplicity, examples provided below may be in the context of the first wireless communication technology being a wireless communication technology in accordance with the IEEE 802.11 specifications, protocols and standards, and the second wireless communication technology being a wireless communication technology in accordance with the Bluetooth and/or BLE specifications, protocols and standards.

In network environment 100, each of STAs 120(1)-120(N) may be capable of operating in one of multiple operational modes. For instance, each of STAs 120(1)-120(N) may be in a first mode or a normal operational mode. Additionally, each of STAs 120(1)-120(N) may be in a second mode or a power-save mode in which power consumption may be minimized by deactivating a relatively larger number of activities and/or functionalities that would otherwise be enabled in the first mode. Optionally, each of STAs 120(1)-120(N) may be in a third mode or a low-power mode in which a relatively smaller number of activities and/or functionalities, which would otherwise be enabled in the first mode, may be deactivated. To conserve energy or otherwise minimize power consumption, each of STAs 120(1)-120(N) may enter the second mode when there is no traffic (e.g., data packets) from AP 110, and may enter the first mode (or the third mode if available) when there is need to “wake up” to receive broadcast, multicast and/or unicast packets from AP 110.

Under the proposed scheme, a power management-related bit (hereinafter interchangeably referred as the “power-save bit” or “PS bit”) may be reserved in the frame control field in 802.11 wireless local area network (WLAN) media access control (MAC) header in a null frame transmitted by a STA to AP 110. This reserved PS bit in the frame control field of the WLAN MAC header in the null frame may be utilized by each of STAs 120(1)-120(N) to communicate to AP 110 its intent to enter or exit the second mode or the power-save mode. For instance, each of STAs 120(1)-120(N) may set the PS bit (e.g., by setting the PS bit to a binary value of 1) to indicate its intention to enter the power-save mode or reset the PS bit (e.g., by setting the PS bit to a binary value of 0) to indicate its intention to exit the power-save mode (and entering the normal operational mode or the low-power mode).

Under the proposed scheme, status of packets buffered at AP 110 may be communicated by AP 110 to a given STA among STAs 120(1)-120(N) in the power-save mode via an active Bluetooth/BLE connection between Bluetooth/BLE peers present at AP 110 and the STA in concern. AP 110 may communicate the status of buffered packets (e.g., that there are buffered broadcast, multicast and/or unicast packets for the STA) to a corresponding Bluetooth/BLE communication device of AP 110, which in turn may communicate such status via one or more messages to one or more Bluetooth/BLE communication devices in one or more of STAs 120(1)-120(N) in network 105. The Bluetooth/BLE communication device of a STA may further notify a corresponding Wi-Fi communication device of that STA based on the received message(s) from the Bluetooth/BLE communication device of AP 110. The STA may then decide whether or not to exit the power-save mode to receive the buffered packets from AP 110.

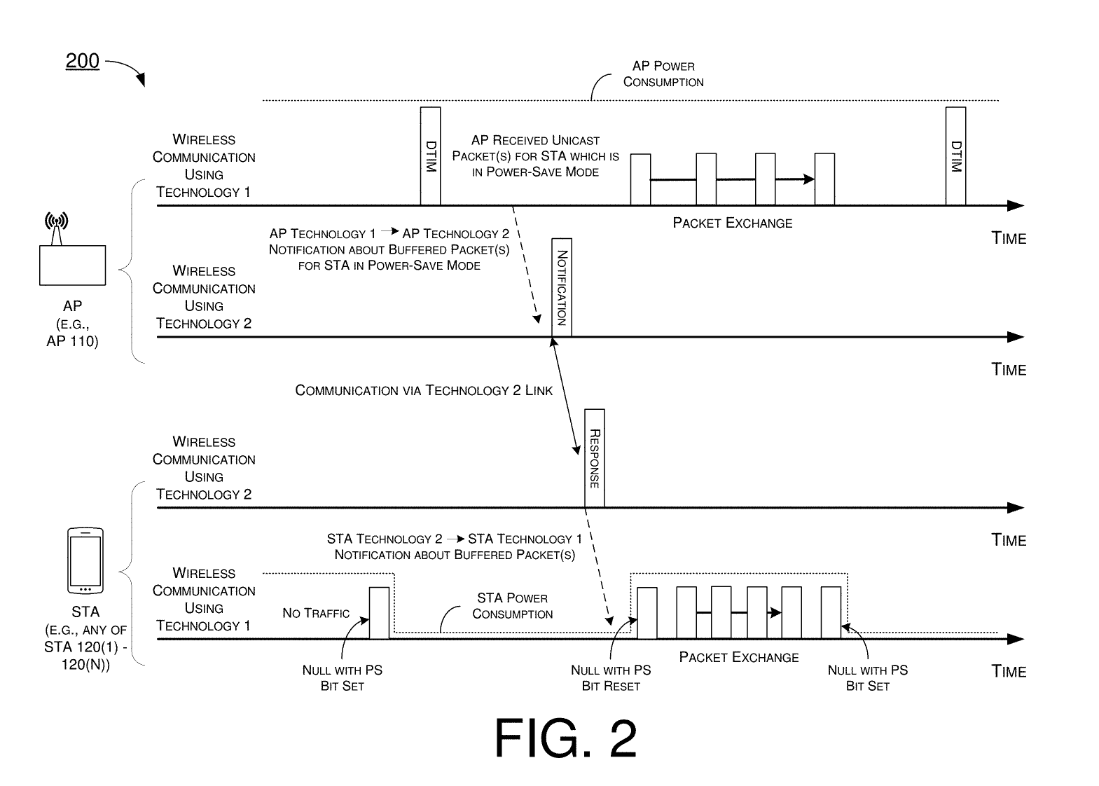

FIG. 2 illustrates an example scenario 200 in accordance with an implementation of the present disclosure. Scenario 200 may involve an AP (e.g., AP 110) and a STA (e.g., any of STAs 120(1)-120(N)) having active communication connections using a first wireless communication technology via a first communication link (denoted as “technology 1 link” in FIG. 2) and using a second wireless communication technology via a second communication link (denoted as “technology 2 link” in FIG. 2). For simplicity, in the following description of scenario 200, the first wireless communication technology refers to Wi-Fi, and the second wireless communication technology refers to Bluetooth/BLE.

In scenario 200, initially the STA may decide to enter a power-save mode upon determining that there is no traffic (e.g., data packets) to be received from the AP. The STA may transmit a null frame, with a PS bit set to 1, to the AP to indicate its intention to enter the power-save mode. Subsequently, the STA may enter the power-save mode, including deactivation of its Wi-Fi communication device, thereby reducing power consumption. When the AP receives one or more unicast packets destined for the STA, which is in the power-save mode at the time, the AP may buffer the packets and notify the STA. In particular, referring to FIG. 2, the AP may communicate the status or existence of the buffered unicast packets to the STA by transmitting a notification from its Bluetooth/BLE communication device to a Bluetooth/BLE communication device of the STA. Upon receiving the notification, the STA may determine whether or not to “wake up” or otherwise exit the power-save mode to receive the unicast packets. The STA may also transmit a response or acknowledgment to the AP from its Bluetooth/BLE communication device to acknowledge receipt of the notification. This may include activating its Wi-Fi communication device to receive the buffered unicast packets from a corresponding Wi-Fi communication device of the AP. The STA may transmit a null frame, with the PS bit reset to 0, to the AP to indicate its intention to exit the power-save mode. Upon completion of packet exchange with the AP, the STA may re-enter the power-save mode for power conservation. Again, the STA may transmit a null frame, with the PS bit set to 1, to the AP to indicate its intention to enter the power-save mode.

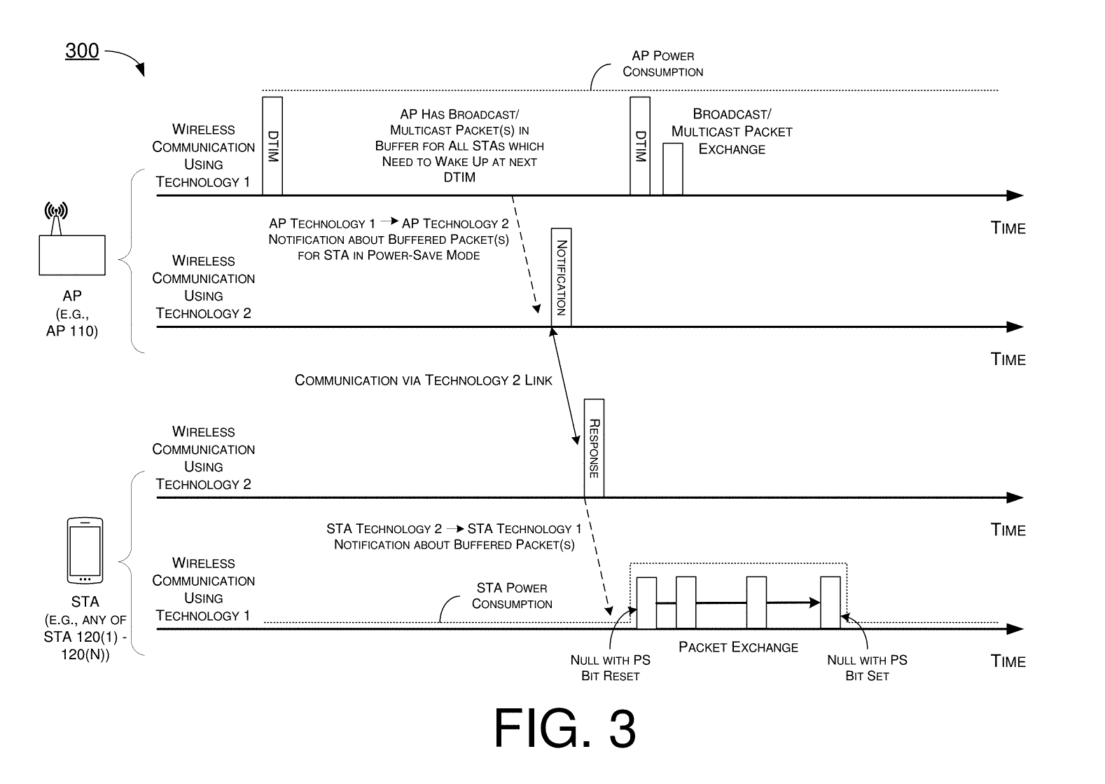

FIG. 3 illustrates an example scenario 300 in accordance with an implementation of the present disclosure. Scenario 300 may involve an AP (e.g., AP 110) and a STA (e.g., any of STAs 120(1)-120(N)) having active communication connections using a first wireless communication technology via a first communication link (denoted as “technology 1 link” in FIG. 3) and using a second wireless communication technology via a second communication link (denoted as “technology 2 link” in FIG. 3). For simplicity, in the following description of scenario 300, the first wireless communication technology refers to Wi-Fi, and the second wireless communication technology refers to Bluetooth/BLE.

In scenario 300, initially the STA may be in a power-save mode, with its Wi-Fi communication device deactivated so as to reduce power consumption. When the AP receives one or more broadcast and/or multicast packets for which the STA is a recipient, the AP may buffer the packets and notify the STA. In particular, referring to FIG. 3, the AP may communicate the status or existence of the buffered broadcast/multicast packets to the STA by transmitting a notification from its Bluetooth/BLE communication device to a Bluetooth/BLE communication device of the STA. The notification may notify the STA that the AP will transmit the buffered broadcast/multicast packets at the next DTIM and thus the STA needs to exit or otherwise wake up from the power-save mode. Upon receiving the notification, the STA may transmit a response or acknowledgment to the AP from its Bluetooth/BLE communication device to acknowledge receipt of the notification. The STA may also activate its Wi-Fi communication device to receive the buffered broadcast/multicast packets from a corresponding Wi-Fi communication device of the AP. The STA may transmit a null frame, with the PS bit reset to 0, to the AP to indicate its intention to exit the power-save mode. Upon completion of packet exchange with the AP, the STA may re-enter the power-save mode for power conservation. Again, the STA may transmit a null frame, with the PS bit set to 1, to the AP to indicate its intention to enter the power-save mode.

### Illustrative Implementations

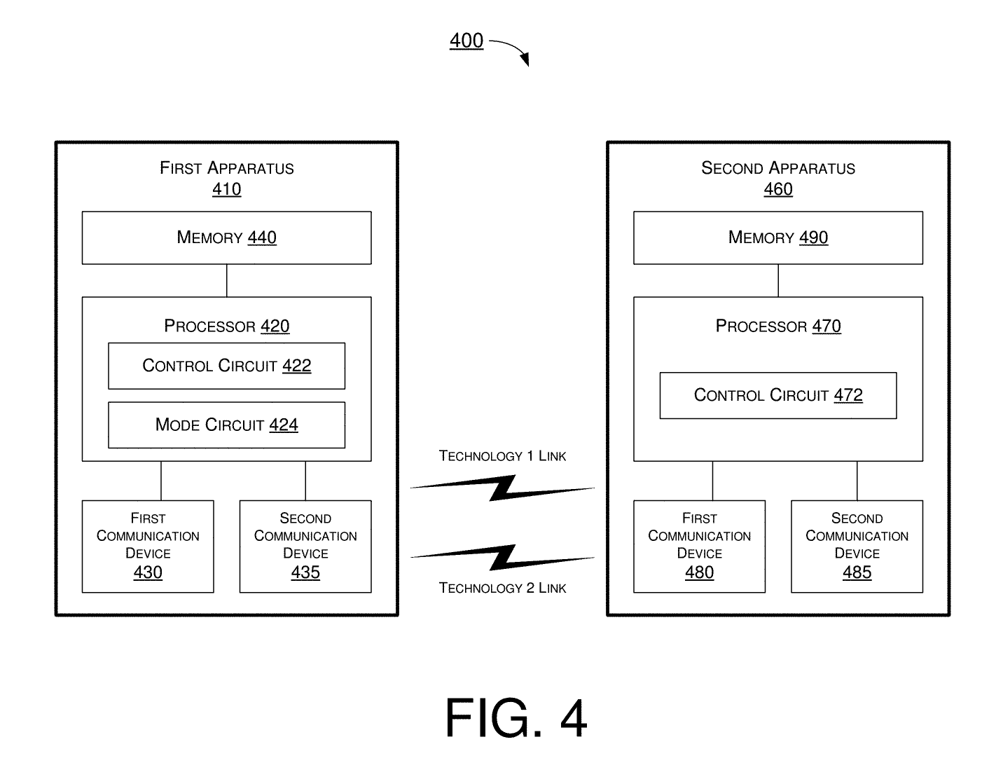

FIG. 4 illustrates an example system 400 of a first apparatus 410 and a second apparatus 460 in accordance with an implementation of the present disclosure. First apparatus 410 and second apparatus 460 may perform various functions as a UE or STA to implement schemes, solutions, techniques, processes and methods described herein pertaining to Wi-Fi STA using coexistent low-power wireless communications capabilities, including those described above with respect to network environment 100, scenario 200 and scenario 300 as well as process 500 and process 600 described below. Second apparatus 460 may perform various functions as an AP, software-enabled AP or virtual router to implement schemes, solutions, techniques, processes and methods described herein pertaining to Wi-Fi STA using coexistent low-power wireless communications capabilities, including those described above with respect to network environment 100, scenario 200 and scenario 300 as well as process 500 and process 600 described below.

Each of first apparatus 410 and second apparatus 460 may be a part of an electronic apparatus which may be a communication device, a computing apparatus, a portable or mobile apparatus, or a wearable apparatus. For instance, first apparatus 410 may be implemented in a Wi-Fi STA or UE, a smartphone, a smartwatch, a smart bracelet, a smart necklace, a personal digital assistant, or a computing device such as a tablet computer, a laptop computer, a notebook computer, a desktop computer, or a server. Likewise, second apparatus 460 may be implemented in a repeater, a Wi-Fi AP, a smartphone, a smartwatch, a smart bracelet, a smart necklace, a personal digital assistant, or a computing device such as a tablet computer, a laptop computer, a notebook computer, a desktop computer, or a server. Alternatively, each of first apparatus 410 and second apparatus 460 may be implemented in the form of one or more integrated-circuit (IC) chips such as, for example and not limited to, one or more single-core processors, one or more multi-core processors, or one or more complex-instruction-set-computing (CISC) processors. Each of first apparatus 410 and second apparatus 460 may include at least some of those components shown in FIG. 4, respectively. For instance, first apparatus 410 may include at least a processor 420, and second apparatus 460 may include at least a processor 470.

In one aspect, each of processor 420 and processor 470 may be implemented in the form of one or more single-core processors, one or more multi-core processors, or one or more CISC processors. That is, even though a singular term “a processor” is used herein to refer to each of processor 420 and processor 470, each of processor 420 and processor 470 may include multiple processors in some implementations and a single processor in other implementations in accordance with the present disclosure. In another aspect, each of processor 420 and processor 470 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 420 and processor 470 is a special-purpose machine specifically designed, arranged and configured to perform specific tasks including Wi-Fi STA using coexistent low-power wireless communications capabilities in accordance with various implementations of the present disclosure.

Processor 410, as a special-purpose machine, may include non-generic and specially-designed hardware circuits that are designed, arranged and configured to perform specific tasks pertaining to Wi-Fi STA using coexistent low-power wireless communications capabilities in accordance with various implementations of the present disclosure. In one aspect, processor 420 may include a control circuit 422 and a mode circuit 424 that, together, perform specific tasks and functions in accordance with various implementations of the present disclosure.

Processor 460, as a special-purpose machine, may include non-generic and specially-designed hardware circuits that are designed, arranged and configured to perform specific tasks pertaining to Wi-Fi STA using coexistent low-power wireless communications capabilities in accordance with various implementations of the present disclosure. In one aspect, processor 470 may include a control circuit 472 that performs specific tasks and functions in accordance with various implementations of the present disclosure.

In some implementations, first apparatus 410 may include a memory 440, and second apparatus 460 may include a memory 490. Each of memory 440 and memory 490 may be a storage device configured to store one or more sets of codes, programs and/or instructions and/or data therein. In the example shown in FIG. 4, memory 440 stores one or more sets of processor-executable instructions 422 and data 424 therein, and memory 490 stores one or more sets of processor-executable instructions 472 and data 474 therein. Each of memory 440 and memory 490 may be implemented by any suitable technology and may include volatile memory and/or non-volatile memory. For example, each of memory 440 and memory 490 may include a type of random-access memory (RAM) such as dynamic RAM (DRAM), static RAM (SRAM), thyristor RAM (T-RAM) and/or zero-capacitor RAM (Z-RAM). Alternatively or additionally, each of memory 440 and memory 490 may include a type of read-only memory (ROM) such as mask ROM, programmable ROM (PROM), erasable programmable ROM (EPROM) and/or electrically erasable programmable ROM (EEPROM). Alternatively or additionally, each of memory 440 and memory 490 may include a type of non-volatile random-access memory (NVRAM) such as flash memory, solid-state memory, ferroelectric RAM (FeRAM), magnetoresistive RAM (MRAM) and/or phase-change memory.

In one aspect, processor 420 may execute the one or more sets of codes, programs and/or instructions stored in memory 440 to perform various operations in accordance with various implementations of the present disclosure. In one aspect, processor 470 may execute the one or more sets of codes, programs and/or instructions stored in memory 490 to perform various operations in accordance with various implementations of the present disclosure.

In some implementations, first apparatus 410 may also include a first communication device 430 and a second communication device 435. Frist communication device 430 may be configured to transmit and receive data wirelessly using a first wireless communication technology (e.g., in compliance with the IEEE 802.11 specifications, protocols and standards). Second communication device 435 may be configured to transmit and receive data wirelessly using a second wireless communication technology (e.g., in compliance with the Bluetooth and/or BLE specifications, protocols and standards). Each of first communication device 430 and second communication device 435 may be communicatively and operably coupled to processor 420 to be controlled by processor 420. When communicating with another apparatus (e.g., second apparatus 460), first apparatus 410 consumes less power by using the second wireless communication technology via second communication device 435 than using the first wireless communication technology via first communication device 430.

In some implementations, first apparatus 460 may also include a first communication device 480 and a second communication device 485. Frist communication device 480 may be configured to transmit and receive data wirelessly using a first wireless communication technology (e.g., in compliance with the IEEE 802.11 specifications, protocols and standards). Second communication device 485 may be configured to transmit and receive data wirelessly using a second wireless communication technology (e.g., in compliance with the Bluetooth and/or BLE specifications, protocols and standards). Each of first communication device 480 and second communication device 485 may be communicatively and operably coupled to processor 470 to be controlled by processor 470. When communicating with another apparatus (e.g., first apparatus 410), second apparatus 460 consumes less power by using the second wireless communication technology via second communication device 485 than using the first wireless communication technology via first communication device 480. Thus, first apparatus 410 and second apparatus 460 may establish communication links, including a first communication link (denoted as “technology 1 link”) based on the first wireless communication technology between first communication device 430 and second communication device 480 as well as a second communication link (denoted as “technology 2 link”) based on the second wireless communication technology between second communication device 435 and second communication device 485.

Each of first apparatus 410 and second apparatus 460 may further include other components (e.g., power system, display device and user interface device), which are not pertinent to the proposed scheme of the present disclosure and, thus, are neither shown in FIG. 4 nor described herein in the interest of simplicity and brevity.

In some implementations, mode circuit 424 of processor 420 may cause first apparatus 410 to enter a second mode from a first mode with respect to communications with another apparatus (e.g., second apparatus 460), such as an AP, using the first wireless communication technology via first communication device 430. Additionally, control circuit 422 of processor 420 may receive a notification from the AP using the second wireless communication technology via second communication device 435. Moreover, control circuit 422 may analyze content of the notification to determine whether or not to enter the first mode or a third mode from the second mode. In response to receiving the notification and control circuit 422 determining to enter the first or third mode, mode circuit 424 may cause first apparatus 410 to enter the first mode or the third mode from the second mode with respect to communications with the AP using the first wireless communication technology via the first communication device.

In some implementations, the first mode may include a normal operational mode, the second mode may include a power-save mode, and the third mode may include a low-power operational mode.

In some implementations, the first wireless communication technology may include a radio frequency (RF)-based wireless communication technology in compliance with the IEEE 802.11 specifications. Moreover, the second wireless communication technology may include an RF-based wireless communication technology in compliance with Bluetooth/BLE specifications or another wireless communication technology based on acoustics, optics, magnetics, electromagnetics, or infrared.

In some implementations, processor 420 may be also capable of receiving one or more packets from the AP using the first wireless communication technology via first communication device 430 after causing first apparatus 410 to enter the first mode or the third mode from the second mode. Additionally, processor 420 may be further capable of causing first apparatus 410 to enter the second mode from the first mode or the third mode after receiving the one or more packets.

In some implementations, control circuit 472 of processor 470 of second apparatus 460, functioning as an AP, may be capable of receiving one or more packets destined for a UE or STA (e.g., first apparatus 410) which is in a power-save mode with respect to communications with the AP using a first wireless communication technology. Control circuit 472 may be capable of buffering the one or more packets in a storage device (e.g., memory 490) of second apparatus 460. Control circuit 472 may be capable of transmitting a notification to the UE/STA regarding the one or more packets using a second wireless communication technology different from the first wireless communication technology via second communication device 485. Control circuit 472 may also be capable of receiving a response or acknowledgment from the UE/STA using the first wireless communication technology via first communication device 480. Control circuit 472 may be further capable of transmitting the one or more packets to the UE using the first wireless communication technology via first communication device 480 upon receiving the response or acknowledgment from the UE/STA.

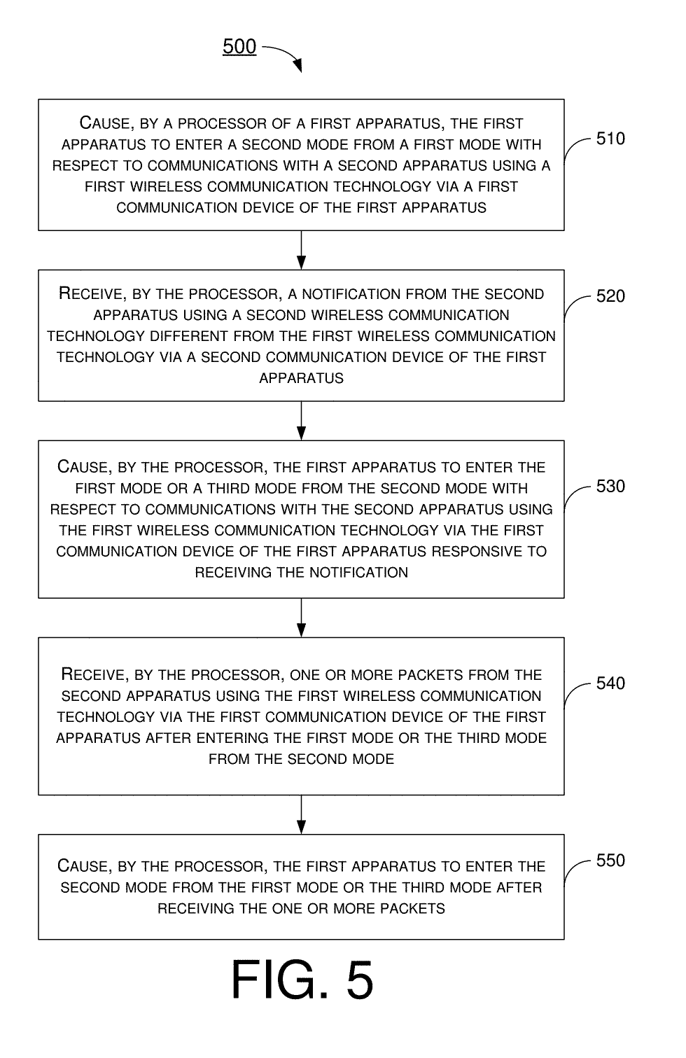

FIG. 5 illustrates an example process 500 in accordance with an implementation of the present disclosure. Process 500 may represent an aspect of implementing schemes, solutions, techniques and/or methods in accordance with the present disclosure pertaining to Wi-Fi STA using coexistent low-power wireless communications capabilities. Process 500 may include one or more operations, actions, or functions as illustrated by one or more of blocks 510, 520, 530, 540 and 550. Although illustrated as discrete blocks, various blocks of process 500 may be divided into additional blocks, combined into fewer blocks, or eliminated, depending on the desired implementation. Moreover, the blocks/sub-blocks of process 500 may executed in the order shown in FIG. 5 or, alternatively in a different order. Process 500 may be implemented by first apparatus 410 or second apparatus 460, as well as any variations thereof. For instance, process 500 may be implemented in or by first apparatus 410 functioning as a UE or one of the STAs 120(1)-120(N) in network environment 100, scenario 200 and/or scenario 300. Solely for illustrative purposes, process 500 is described below in the context of first apparatus 410 being a STA and second apparatus 460 being an AP. Process 500 may begin at block 510.

At 510, process 500 may involve processor 420 of first apparatus 410 entering a second mode from a first mode with respect to communications with second apparatus 460 using a first wireless communication technology via first communication device 430 of first apparatus 410. Process 500 may proceed from 510 to 520.

At 520, process 500 may involve processor 420 receiving a notification from second apparatus 460 using a second wireless communication technology different from the first wireless communication technology via second communication device 435 of first apparatus 410. Process 500 may proceed from 520 to 530.

At 530, process 500 may involve processor 420 entering the first mode or a third mode from the second mode with respect to communications with second apparatus 460 using the first wireless communication technology via first communication device 430 of first apparatus 410 in response to receiving the notification. Process 500 may proceed from 530 to 540.

At 540, process 500 may involve processor 420 receiving one or more packets from second apparatus 460 using the first wireless communication technology via first communication device 430 of first apparatus 410 after entering the first mode or the third mode from the second mode. Process 500 may proceed from 540 to 550.

At 550, process 500 may involve processor 420 entering the second mode from the first mode or the third mode after receiving the one or more packets.

In some implementations, the first mode may be a normal operational mode, the second mode may be a power-save mode, and the third mode may be a low-power operational mode.

In some implementations, the first wireless communication technology may include an RF-based wireless communication technology in compliance with the IEEE 802.11 specifications.

In some implementations, the second wireless communication technology may include an RF-based wireless communication technology in compliance with Bluetooth or BLE specifications. Alternatively or additionally, the second wireless communication technology may include a wireless communication technology based on acoustics, optics, magnetics, electromagnetics, or infrared. When communicating with first second apparatus 460, second first apparatus 410 may consume less power by using the second wireless communication technology than using the first wireless communication technology.

In some implementations, in entering the first mode or the third mode from the second mode, process 500 may involve processor 420 performing a number of operations. For instance, process 500 may involve processor 420 analyzing the notification. Additionally, process 500 may involve processor 420 determining whether or not to enter the first mode or the third mode from the second mode based on a result of the analyzing. Moreover, process 500 may involve processor 420 entering the first mode or the third mode from the second mode responsive to the result of the analyzing indicating a need for the first apparatus to enter the first mode or the third mode to receive one or more packets from the second apparatus.

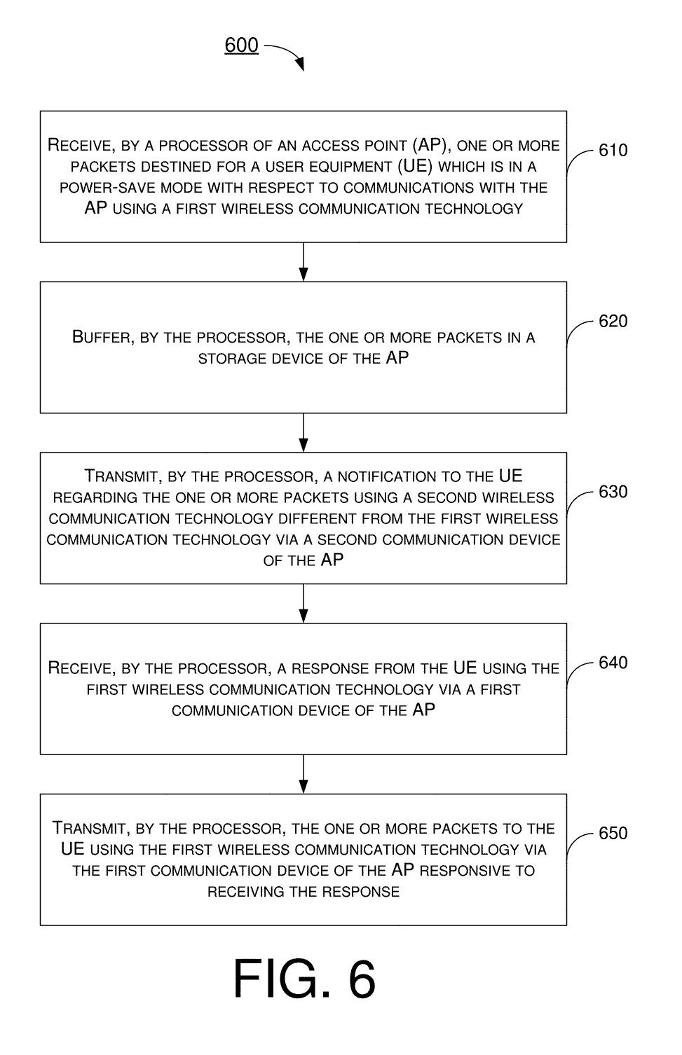

FIG. 6 illustrates an example process 600 in accordance with an implementation of the present disclosure. Process 600 may represent an aspect of implementing schemes, solutions, techniques and/or methods in accordance with the present disclosure pertaining to Wi-Fi STA using coexistent low-power wireless communications capabilities. Process 600 may include one or more operations, actions, or functions as illustrated by one or more of blocks 610, 620, 630, 640 and 650. Although illustrated as discrete blocks, various blocks of process 600 may be divided into additional blocks, combined into fewer blocks, or eliminated, depending on the desired implementation. Moreover, the blocks/sub-blocks of process 600 may executed in the order shown in FIG. 6 or, alternatively in a different order. Process 600 may be implemented by first apparatus 410 or second apparatus 460, as well as any variations thereof. For instance, process 600 may be implemented in or by second apparatus 460 functioning as an AP such as AP 110 in network environment 100, scenario 200 and/or scenario 300. Solely for illustrative purposes, process 600 is described below in the context of first apparatus 410 being a STA and second apparatus 460 being an AP. Process 600 may begin at block 610.

At 610, process 600 may involve processor 470 of second apparatus 460 receiving (e.g., from a service provider, a different network or the internet) one or more packets destined for first apparatus 410 (as a UE or one of STAs 120(1)-120(N)) which is in a power-save mode with respect to communications with second apparatus 460 using a first wireless communication technology. Process 600 may proceed from 610 to 620.

At 620, process 600 may involve processor 470 buffering the one or more packets in a storage device (e.g., memory 490) of second apparatus 460. Process 600 may proceed from 620 to 630.

At 630, process 600 may involve processor 470 transmitting a notification to first apparatus 410 regarding the one or more packets using a second wireless communication technology different from the first wireless communication technology via second communication device 485 of second apparatus 460. Process 600 may proceed from 630 to 640.

At 640, process 600 may involve processor 470 receiving a response from first apparatus 410 using the first wireless communication technology via first communication device 480 of second apparatus 460. Process 600 may proceed from 640 to 650.

At 650, process 600 may involve processor 470 transmitting the one or more packets to first apparatus 410 using the first wireless communication technology via first communication device 480 of second apparatus 460 upon receiving the response from first apparatus 410.

In some implementations, the first wireless communication technology may include an RF-based wireless communication technology in compliance with the IEEE 802.11 specifications.

In some implementations, the second wireless communication technology may include an RF-based wireless communication technology in compliance with Bluetooth or BLE specifications. Alternatively or additionally, the second wireless communication technology may include a wireless communication technology based on acoustics, optics, magnetics, electromagnetics, or infrared. When communicating with first second apparatus 460, second first apparatus 410 may consume less power by using the second wireless communication technology than using the first wireless communication technology.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
causing, by a processor of a first apparatus, the first apparatus to enter a second mode from a first mode with respect to communications with a second apparatus using a first wireless communication technology via a first communication device of the first apparatus;
receiving, by the processor, a notification from the second apparatus using a second wireless communication technology different from the first wireless communication technology via a second communication device of the first apparatus; and
causing, by the processor, the first apparatus to enter the first mode or a third mode from the second mode with respect to communications with the second apparatus using the first wireless communication technology via the first communication device of the first apparatus responsive to receiving the notification.

2. The method of claim 1, wherein the first mode comprises a normal operational mode, wherein the second mode comprises a power-save mode, and wherein the third mode comprises a low-power operational mode.

3. The method of claim 1, wherein the first wireless communication technology comprises a radio frequency (RF)-based wireless communication technology in compliance with Institute of Electrical and Electronics Engineers (IEEE) 802.11 specifications.

4. The method of claim 1, wherein the second wireless communication technology comprises a radio frequency (RF)-based wireless communication technology in compliance with Bluetooth or Bluetooth Low Energy (BLE) specifications.

5. The method of claim 1, wherein the second wireless communication technology comprises a wireless communication technology based on acoustics, optics, magnetics, electromagnetics, or infrared.

6. The method of claim 1, wherein the causing of the first apparatus to enter the first mode or the third mode from the second mode comprises:
analyzing the notification;
determining whether or not to enter the first mode or the third mode from the second mode based on a result of the analyzing; and
causing the first apparatus to enter the first mode or the third mode from the second mode responsive to the result of the analyzing indicating a need for the first apparatus to enter the first mode or the third mode to receive one or more packets from the second apparatus.

7. The method of claim 1, further comprising:
receiving, by the processor, one or more packets from the second apparatus using the first wireless communication technology via the first communication device of the first apparatus after entering the first mode or the third mode from the second mode.

8. The method of claim 7, further comprising:
causing, by the processor, the first apparatus to enter the second mode from the first mode or the third mode after receiving the one or more packets.

9. A method, comprising:
receiving, by a processor of an access point (AP), one or more packets destined for a user equipment (UE) which is in a power-save mode with respect to communications with the AP using a first wireless communication technology;
buffering, by the processor, the one or more packets in a storage device of the AP;
transmitting, by the processor, a notification to the UE regarding the one or more packets using a second wireless communication technology different from the first wireless communication technology via a second communication device of the AP;
receiving, by the processor, a response from the UE using the first wireless communication technology via a first communication device of the AP; and
transmitting, by the processor, the one or more packets to the UE using the first wireless communication technology via the first communication device of the AP responsive to receiving the response.

10. The method of claim 9, wherein the first wireless communication technology comprises a radio frequency (RF)-based wireless communication technology in compliance with Institute of Electrical and Electronics Engineers (IEEE) 802.11 specifications.

11. The method of claim 9, wherein the second wireless communication technology comprises a radio frequency (RF)-based wireless communication technology in compliance with Bluetooth or Bluetooth Low Energy (BLE) specifications.

12. The method of claim 9, wherein the second wireless communication technology comprises a wireless communication technology based on acoustics, optics, magnetics, electromagnetics, or infrared.

13. An apparatus implementable in a user equipment (UE), comprising:
a first communication device capable of wireless communications using a first wireless communication technology;
a second communication device capable of wireless communications using a second wireless communication technology different from the first wireless communication technology; and
a processor operatively coupled to the first communication device and the second communication device, the processor capable of performing operations comprising:
causing the apparatus to enter a second mode from a first mode with respect to communications with an access point (AP) using the first wireless communication technology via the first communication device;
receiving a notification from the AP using the second wireless communication technology via the second communication device; and
causing the apparatus to enter the first mode or a third mode from the second mode with respect to communications with the AP using the first wireless communication technology via the first communication device responsive to receiving the notification.

14. The apparatus of claim 13, wherein the first mode comprises a normal operational mode, wherein the second mode comprises a power-save mode, and wherein the third mode comprises a low-power operational mode.

15. The apparatus of claim 13, wherein, when communicating with the AP, the UE consumes less power by using the second wireless communication technology than using the first wireless communication technology.

16. The apparatus of claim 13, wherein the first wireless communication technology comprises a radio frequency (RF)-based wireless communication technology in compliance with Institute of Electrical and Electronics Engineers (IEEE) 802.11 specifications.

17. The apparatus of claim 13, wherein the second wireless communication technology comprises a radio frequency (RF)-based wireless communication technology in compliance with Bluetooth or Bluetooth Low Energy (BLE) specifications or another wireless communication technology based on acoustics, optics, magnetics, electromagnetics, or infrared.

18. The apparatus of claim 13, wherein, in causing the apparatus to enter the first mode or the third mode from the second mode, the processor performs operations comprising:
analyzing the notification;
determining whether or not to enter the first mode or the third mode from the second mode based on a result of the analyzing; and
causing the apparatus to enter the first mode or the third mode from the second mode responsive to the result of the analyzing indicating a need for the UE to enter the first mode or the third mode to receive one or more packets from the AP.

19. The apparatus of claim 13, wherein the processor is further capable of receiving one or more packets from the AP using the first wireless communication technology via the first communication device after causing the apparatus to enter the first mode or the third mode from the second mode.

20. The apparatus of claim 19, wherein the processor is further capable of causing the apparatus to enter the second mode from the first mode or the third mode after receiving the one or more packets.
